(19) United States
(12) Patent Application Publication
(10) Pub. No.: US 2024/0166519 A1
(43) Pub. Date: May 23, 2024

(54) CARBON NANOTUBE SHEETS FOR INFRARED SHIELDING AND METHOD OF MAKING THE SAME

(71) Applicant: Technology Innovation Institute - Sole Proprietorship LLC, Masdar City (AE)

(72) Inventors: Juveiriah M. Ashraf, Khalifa City (AE); Myriam Ghodhbane, Abu Dhabi (AE); Abdulrahman Alshaya, Abu Dhabi (AE); Sunil Lonkar, Abu Dhabi (AE); Zainab Karam, Abu Dhabi (AE); Chiara Busa, Abu Dhabi (AE); Vincenzo Giannini, Abu Dhabi (AE)

(73) Assignee: Technology Innovation Institute - Sole Proprietorship LLC, Masdar City (AE)

(21) Appl. No.: 18/513,952

(22) Filed: Nov. 20, 2023

Related U.S. Application Data
(60) Provisional application No. 63/384,461, filed on Nov. 21, 2022.

(51) Int. Cl. C01B 32/174; B32B 9/00; B32B 9/04; B32B 37/18

(52) U.S. Cl. CPC C01B 32/174; B32B 9/007; B32B 9/04; B32B 37/18; B32B 2313/04; C01P 2004/24; C01P 2006/90

(57) ABSTRACT

A method for producing carbon nanotube sheets is provided. The method may include steps of: dispersing carbon nanotubes and cellulose in a solvent to form a slurry, stirring the slurry, and depositing the slurry onto a substrate using a coating method to form a carbon nanotube sheet. The carbon nanotube sheet may include 0.1 wt. % to about 95 wt. % cellulose relative to the total weight of the carbon nanotube sheet and may have an emissivity of about 0.05 to about 0.3. The carbon nanotube sheet may be utilized to provide infrared shielding to a surface.

### CROSS-REFERENCE TO RELATED APPLICATIONS

This application claims priority to U.S. Provisional Patent Application No. 63/384,461, which was filed on Nov. 21, 2022, the entire contents of which are incorporated by reference herein.

### FIELD

The present disclosure relates generally to methods of producing carbon nanotube sheets. More specifically, the present disclosure relates to methods of producing carbon nanotube sheets in a fast, inexpensive, and scalable manner that results in carbon nanotube sheets for use in infrared shielding.

### BACKGROUND

Infrared (IR) shielding reduces the IR radiation emitting from an object and is desirable for numerous applications. For example, coating an IR shielding material onto a building offers more efficient heat control, and coating an object with an IR shielding material can prevent detection of the object with IR cameras.

Common IR shielding materials can include metals, polymers, semiconductors, and organic/inorganic composites. However, metals as IR shielding materials are heavy and suffer from degradation of shielding properties due to oxidation from long-term air exposure. Polymers and composites are lighter and flexible but offer poor IR shielding performance and mechanical properties. The present disclosure describes cellulose-based carbon nanotube sheets as IR shielding materials, allowing light weight coupled with high performance and using environmentally friendly cellulose, instead of expensive and resource-intensive materials.

Carbon nanotubes are widely employed in many fields, including air and water purification, energy storage, and wearable electronics. Carbon nanotubes may be synthesized via several routes known in the art such as laser ablation, chemical vapor deposition, and membrane filtration, all of which present drawbacks such as high production costs, long synthesis times, and limited scalability.

Recent improvements in the equipment for producing carbon nanotube sheets have allowed variation in the size of sheets that may be produced and substrate which may be used, such as the apparatus and method described in U.S. Pat. No. 11,242,249 B2 and U.S. Provisional Patent Application No. 63/367,756, which are incorporated by reference herein in their entirety. Despite these improvements, there remains a need for fast, scalable methods to produce high-quality carbon nanotube sheets that may be utilized in large-scale applications such as IR shielding.

### SUMMARY

This disclosure describes a method for producing carbon nanotube sheets, wherein the method may include steps of: dispersing carbon nanotubes and cellulose in a solvent to form a slurry, stirring the slurry, and depositing the slurry onto a substrate using a coating method to form a carbon nanotube sheet.

In embodiments, the carbon nanotubes include single-walled carbon nanotubes, double-walled carbon nanotubes, multi-walled carbon nanotubes, or combinations thereof. In embodiments, the slurry includes 0.1 wt. % to about 95 wt. % cellulose. In embodiments, the solvent includes ethanol, water, acetone, dimethylformamide, tetrahydrofuran, dimethylacetamide, dimethyl sulfoxide, isopropyl alcohol, toluene, or combinations thereof. In embodiments, the solvent includes water and ethanol in a ratio of about 1:5 to about 1:2.

In embodiments, stirring the slurry includes stirring with a magnetic stirrer, sonicating, or combinations thereof. In embodiments, the substrate includes a metal, polymer, ceramic, glass, composite, or combinations thereof. In embodiments, the coating method includes tape casting, spray coating, ink-jet printing, or combinations thereof.

In embodiments, the carbon nanotube sheet includes carbon nanotubes and 0.1 wt. % to about 95 wt. % cellulose. In embodiments, the method further includes depositing multiple layers of slurry onto a substrate to form a carbon nanotube sheet with multiple layers. In embodiments, the method further includes a step of removing the carbon nanotube sheet from the substrate to form a freestanding carbon nanotube sheet.

There is provided a carbon nanotube sheet, which may include 0.1 wt. % to about 95 wt. % cellulose relative to the total weight of the carbon nanotube sheet. In embodiments, the carbon nanotube sheet includes about 5 wt. % to about 50 wt. % cellulose. In embodiments, the carbon nanotube sheet includes between 1 layer and 10 layers. In embodiments, the carbon nanotube sheet has a thickness of about 30 μm to about 130 μm. In embodiments, the carbon nanotube sheet has an emissivity of about 0.03 to about 0.7. In embodiments, the carbon nanotube sheet has an emissivity of about 0.05 to about 0.3. In embodiments, the carbon nanotube sheet is freestanding.

There is provided a method of providing infrared shielding to a surface, which may include: applying the carbon nanotube sheet of the present disclosure to the surface. In embodiments, applying the carbon nanotube sheet includes one or more of fabricating the carbon nanotube sheet onto the surface, applying a freestanding carbon nanotube sheet to the surface, applying first a primer and second a freestanding carbon nanotube sheet to the surface, and applying two or more carbon nanotube sheets to the surface.

### DRAWINGS

Aspects, features, benefits, and advantages of the embodiments described herein will be apparent with regard to the following description, appended claims, and accompanying drawings where:

FIG. 1 shows an illustrative diagram of a system that may be used in a method of making carbon nanotube sheets, according to embodiments of the present disclosure.

FIG. 2 is a flow chart of an exemplary method of making carbon nanotube sheets, according to embodiments of the present disclosure.

FIG. 3 is a bar graph showing the relationship between the emissivity of the carbon nanotube sheets and the type of cellulose in the carbon nanotube sheets.

FIG. 4A is a bar graph showing the relationship between the emissivity of the carbon nanotube sheets and the weight percentage of cellulose included in the carbon nanotube sheets, when using multi-walled carbon nanotubes.

FIG. 4B is a graph showing the relationship between emissivity of the carbon nanotubes and the weight percentage of cellulose included in the carbon nanotube sheets, when single single-walled carbon nanotubes and varying the temperature.

FIG. 5 is a bar graph showing the relationship between the emissivity of the carbon nanotube sheets and the thickness of the carbon nanotube sheets.

FIG. 6A and FIG. 6B are FLIR measurements of samples of carbon nanotube sheets produced according to embodiments of the present disclosure. FIG. 6C is a thermograph for the heating plate and a sample containing pure SWCNT showing the temperature field distribution, where the plate temperature was set to 150° C. FIG. 6D is a thermograph for the heating plate and a sample containing SWCNT and 30 wt. % cellulose, according to an embodiment of the present disclosure, showing the temperature field distribution, where the plate temperature was set to 150° C.

FIG. 7A is an SEM image of a SWCNT sheet that does not contain cellulose, and FIG. 7B is an SEM image of a SWCNT sheet containing 30 wt. % cellulose, according to an embodiment of the present disclosure.

FIG. 7C is a UV-Vis spectra for SWCNT and SWCNT/30 wt. % cellulose after 45 minutes of sonication, according to an embodiment of the present disclosure, showing the higher dispersion with nanocellulose.

FIG. 7D shows thermogravimetric (TGA) results for SWCNT with 0 wt. %, 30 wt. % and 75 wt. % cellulose under oxygen gas flow.

### DETAILED DESCRIPTION

The present disclosure describes methods of producing cellulose-based carbon nanotube sheets that may include carbon nanotubes and cellulose in various ratios. The carbon nanotube sheets produced by the disclosed methods may be freestanding, flexible, and foldable, and may be employed in infrared shielding applications. The carbon nanotube sheets and methods described herein may have several advantages over the prior art, including but not limited to low cost, fast processing times, the potential for high-throughput by utilizing roll-to-roll processing, and the ability to tune the length, thickness, density, and/or composition of the carbon nanotube sheets in order to produce sheets with superior properties. Also described are methods of providing infrared shielding to a surface using the carbon nanotube sheets disclosed herein.

As used herein, the term “about” means plus or minus 10% of the numerical value of the number with which it is being used. For example, “about 50%” means in the range of 45-55% and also includes exactly 50%. Where any value is described herein as modified by the term “about,” the exact value is also disclosed.

As used herein, the term “tape-casting” refers to a process wherein a slurry is cast onto a substrate and subsequently dried to form a coated substrate, optionally including additional processing steps.

As used herein, the term “doctor blading” refers to the process of using a doctoring member (which may be a doctor blade) to smooth or level a solution or slurry which has been deposited onto a substrate.

As used herein, the term “carbon nanotube(s)” refers to a tube of carbon having a diameter typically measured in nanometers, and may comprise single-wall carbon nanotubes (SWCNTs), double-walled carbon nanotubes (DWCNT) or multi-walled carbon nanotubes (MWCNTs). The length of the tubes is not particularly limited.

As used herein, the term “carbon nanotube sheets” refers to sheets of carbon nanotubes that have been cast onto a substrate to form a thin layer, or carbon nanotube sheets which have been removed from a substrate to be freestanding. Carbon nanotube sheets may refer to sheets which have one layer or sheets which have multiple layers.

As used herein, the term “dispersion agent” refers to any additive that improves the dispersibility of carbon nanotubes in a solvent. Carbon nanotubes have poor dispersibility in solvents such as water due to strong intermolecular interactions, thus hindering the industrial-scale processing of carbon nanotubes. Water is desirable as a processing solvent over organic solvents, which may be volatile and/or carcinogenic. Functionalizing the surface of carbon nanotubes may improve the dispersibility of the carbon nanotubes, though such functionalization may impact the resulting properties. As such, methods to produce carbon nanotubes may include the use of surfactants such as sodium lauryl sulfate. Triton X-100, or similar compounds to improve the dispersibility of the carbon nanotubes in a solvent.

Efficacy of IR shielding may be evaluated in terms of emissivity. The emissivity of a surface is a measure of how much thermal radiation the surface emits and may be considered a ratio of the thermal radiation of the surface in question relative to the radiation from an ideal black body surface at the same temperature. This ratio may vary between 0 and 1, wherein the surface of a perfect black body has an emissivity of 1 and real objects have emissivities below 1, emitting radiation at relatively lower rates than the perfect black body surface. IR shielding prevents or reduces such emission, and thus lower emissivity values are desirable for IR shielding applications. The present disclosure describes carbon nanotube sheets that may be used as IR shielding materials and a method of making and using such carbon nanotube sheets.

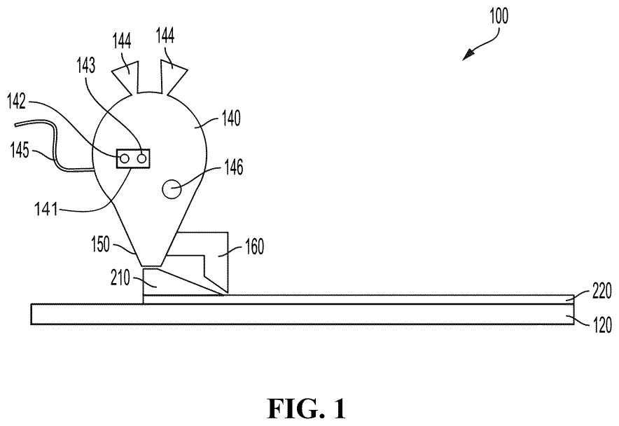

FIG. 1 shows an illustrative diagram of a system that may be used in a method of making carbon nanotube sheets, according to embodiments of the present disclosure, wherein a slurry of carbon nanotubes is contained within a reservoir to be dispensed onto a substrate. There may be included an optional doctoring member to level out the resulting deposited carbon nanotube slurry, according to an embodiment of the present disclosure. The overall system 100 includes a slurry of carbon nanotubes 210, which is contained within a reservoir 140. A dispenser 150 is connected to the reservoir 140 and is used to dispense the slurry of carbon nanotubes onto a substrate 120. A conveyor 130 may move the substrate 120 to allow continuous dispersion of slurry 210. The reservoir may include a mixing and homogenizing device 141, which may include a mixing device 142 and/or a homogenizing device 143, reservoir inlets 144, vacuum lines 145, and a degassing device 146. A doctoring member 160 may be optionally connected to the reservoir 140, or may be separate therefrom.

The dispenser 150 is configured to dispense the slurry onto the surface of the substrate 120. The dispenser 150 may be a standard dispenser or a spray dispenser. In embodiments, the substrate 120 may be placed on a conveyor 130 and may be moveable with the conveyor 130, so as to allow continuous dispensing of the slurry 210. In embodiments, the substrate 120 may be on a conveyor belt.

The slurry of carbon nanotubes 210 may include carbon nanotube material, which may include carbon nanotube powder, carbon nanotube flakes, carbon nanotube pellets, or combinations thereof. The carbon nanotube material may include single-walled carbon nanotubes, double-walled carbon nanotubes, multi-walled carbon nanotubes, or combinations thereof. The slurry 210 may also include functional materials such as surfactants, dispersing agents, emulsifying agents, binders, metals, metal oxides, metal alloys, and/or carbonaceous material. The functional materials may be organic and/or inorganic functional materials. Example metals include, but are not limited to, copper, aluminum, iron, cobalt, nickel, zinc, vanadium, chromium, titanium, manganese, silver, platinum, gold, tantalum, tungsten, palladium, lead, antimony, tin, and/or gallium. Example metal oxides include, but are not limited to, SiO₂, HfO₂, Fe₂O₃, Fe₃O₄, V₂O₅, TiO₂, WO₂, VO₂, ZrO₂, Al₂O₃, Cr₂O₃, Er₂O₃, Ni₂O₃, W₂O₃, V₂O₃, VO, ZnO, NiO, CaO, FeO, RuO₂, MnO₂, Co₃O₄, SnO₂, and/or In₂O₃. Example metal alloys include, but are not limited to, stainless steel, bronze, brass, alnico, nichrome, ferroalloys (e.g., ferrochromium, ferromanganese, ferromolybdenum, ferronickel, ferrosilicon, ferrotitanium, ferrotungsten, ferrovanadium), fernico, kanthal, and/or alumel. Example carbonaceous materials include, but are not limited to, graphite, and/or graphene.

The slurry 210 may include cellulose. The type of cellulose used is not particularly limited, and may include bacterial cellulose (BC), cellulose nanofibers (CNF), cellulose nanocrystals (CNC), microfibrillated cellulose (MFC), nanofibrillated cellulose (NFC), TEMPO-oxidized cellulose nanofibers (TEMPO), or other types of cellulose known to those skilled in the art. The cellulose may include mechanically produced cellulose or chemically produced cellulose. The slurry 210 may include about 0.1 wt. % to about 95 wt. % cellulose, for example, about 0.1 wt. %, about 1 wt. %, about 5 wt. %, about 6 wt. %, about 7 wt. %, about 8 wt. %, about 9 wt. %, about 10 wt. %, about 11 wt. %, about 12 wt. %, about 13 wt. %, about 14 wt. %, about 15 wt. %, about 16 wt. %, about 17 wt. %, about 18 wt. %, about 19 wt. %, about 20 wt. %, about 21 wt. %, about 22 wt. %, about 23 wt. %, about 24 wt. %, about 25 wt. %, about 26 wt. %, about 27 wt. %, about 28 wt. %, about 29 wt. %, about 30 wt. %, about 31 wt. %, about 32 wt. %, about 33 wt. %, about 34 wt. %, about 35 wt. %, about 36 wt. %, about 37 wt. %, about 38 wt. %, about 39 wt. %, about 40 wt. %, about 41 wt. %, about 42 wt. %, about 43 wt. %, about 44 wt. %, about 45 wt. %, about 46 wt. %, about 47 wt. %, about 48 wt. %, about 49 wt. %, about 50 wt. %, about 51 wt. %, about 52 wt. %, about 53 wt. %, about 54 wt. %, about 55 wt. %, about 56 wt. %, about 57 wt. %, about 58 wt. %, about 59 wt. %, about 60 wt. %, about 61 wt. %, about 62 wt. %, about 63 wt. %, about 64 wt. %, about 65 wt. %, about 66 wt. %, about 67 wt. %, about 68 wt. %, about 69 wt. %, about 70 wt. %, about 71 wt. %, about 72 wt. %, about 73 wt. %, about 74 wt. %, about 75 wt. %, about 80 wt. %, about 85 wt. %, about 90 wt. %, about 95 wt. %, or any value contained within a range formed by any two of the preceding values.

The slurry 210 may include carbon nanotubes and cellulose dispersed in a solvent. In embodiments, the solvent may include water and/or an alcohol (e.g., methanol, ethanol, and/or isopropanol), and/or an organic fluid (e.g., acetone, dimethylformamide, tetrahydrofuran, dimethylacetamide, toluene, and/or dimethyl sulfoxide). In embodiments, the solvent may include water and the alcohol and/or organic fluid in a ratio by weight in a range of about 75:25 or about 0:100. For example, the solvent may include water and ethanol in a ratio by weight of about 75:25 to about 0:100 or the solvent may include water and acetone in a ratio by weight of about 75:25 to about 0:100. In embodiments, the solvent may include water and ethanol in a ratio of about 1:5, about 1:4, about 1:3, about 1:2, or any value contained within a range formed by any two of the preceding values. In embodiments, the solvent may include water, methanol, ethanol, isopropanol, acetone, dimethylformamide, tetrahydrofuran, dimethylacetamide, toluene, and/or dimethyl sulfoxide, or combinations thereof.

In embodiments, the carbon nanotube slurry 210 may include a dispersion agent. The dispersion agent may include polyethylene glycol (PEG), sodium lauryl sulfate, sodium dodecylbenzenesulfonate (SDBS), Triton X-100 ((C₁₄H₂₂O(C₂H₄O)ₙ), sodium alginate, or combinations thereof. In embodiments, there may be no dispersion agent included.

The slurry reservoir 140, as shown in FIG. 1, may include a mixing/homogenizing device 141, which may include a mixing device 142 or a homogenizing device 143. The mixing device 142 may include a mixing member, sonicator, agitator, and/or a shaker. In embodiments, the mixing device 142 and the homogenizing device 143 may be configured to operate simultaneously or individually. In embodiments, the reservoir 140 and/or the mixing/homogenizing device 141 may be connected to vacuum lines 145 for degassing of the slurry.

Degassing of the slurry 210 may at least partially remove bubbles in the slurry. The degassing device 146 may include vacuum generators. In embodiments, the degassing device 146 may be inside the slurry reservoir 140 and/or the mixing/homogenizing device 141 and may be connected to external vacuum lines 145. For example, degassing of the slurry may be carried out under pressure less than 0.01 mbar using external vacuum generators connected to the external vacuum lines or the degassing devices. Degassing of the slurry may be carried out for about 1 second to about 1 minute, 1 second or about 1 hour, or any range contained therein, at a temperature at or above room temperature. In embodiments, the mixing/homogenizing device 141 may be connected to external vacuum lines 145 and/or may include the degassing device 146. Degassing of the slurry may be carried out after mixing and sonication are completed. In embodiments, degassing of the slurry may be carried out simultaneously with mixing and sonication.

The carbon nanotube slurry 210 may be deposited onto a substrate 120 using a coating method. In embodiments, the substrate 120 may include a flexible or rigid metal, a metal alloy or metal oxide, a polymeric material, a ceramic, a glass, a glass-laminated polymer, a composite, or combinations thereof. In embodiments, the substrate may have a predetermined shape, such as a round shape, a rectangular shape, a U-shape, a perforated square shape, a tube shape, a mesh shape, or an I-shape. The carbon nanotube sheets produced by the method of the present disclosure may have a shape that is the same as the shape of the substrate. In embodiments, there may be multiple substrates which may have the same shapes or be of different shapes. In embodiments, the surface of the substrate may include a patterned or textured surface (e.g., a hammered, slotted, and/or perforated surface) or a non-patterned surface. In embodiments, the surface of the substrate may include a microscopic patterned surface (e.g., a micro-pyramid structured surface, a micro-pillar structured surface) or a microscopic non-patterned surface (e.g., a smooth and/or polished surface). In embodiments, the substrate may include surface roughness or unevenness including but not limited to grooves, perforations, cracks, pebbles, dimples, etchings, or combinations thereof.

The size of the substrate 120 is not particularly limited. In embodiments, the substrate may be at least about 0.1 m in length. In embodiments, the substrate may be at least about 1 m in length. The substrate may have square, rectangular, circular, or other dimensions. In embodiments, the method of the present disclosure may be used in roll-to-roll printing. In embodiments, the substrate may be at least about 10 m in length, at least about 20 m, at least about 30 m in length, at least about 40 m in length, at least about 50 m in length, at least about 60 m in length, at least about 70 m in length, at least about 80 m in length, at least about 90 m in length, or at least about 100 m in length.

There may be included a doctoring member 160 which is optionally connected to the reservoir 140 and dispenser 150, or may be unattached. FIG. 1 shows the doctoring member 160 is attached, but other embodiments of the present disclosure may include an unattached doctoring member. The purpose of the doctoring member 160 is to level the dispensed carbon nanotube slurry 210 to form a carbon nanotube sheet 220 which is uniform in thickness. In embodiments, the doctoring member 160 is a doctor blade. The doctoring member 160 may be perpendicular to the plane of the substrate 120, or the doctoring member 160 may form an acute angle with the plane of the substrate. The doctoring member 160 may be spaced apart from the surface of the substrate by a predetermined distance. For example, the doctoring member 160 and the substrate 120 may be separated by a distance of about 0.01 mm to about 10,000 mm, about 0.01 mm to about 1,000 mm, about 0.01 to about 100 mm, about 0.01 mm to about 10 mm, about 0.01 mm to about 1 mm, about 1 mm to about 10 mm, about 1 mm to about 100 mm, about 10 mm to about 100 mm, about 10 mm to about 10,000 mm, or any range which is contained within about 0.01 mm to about 10,000 mm. The doctoring member may be used to smooth or even out the deposited carbon nanotube slurry during the formation of a carbon nanotube sheet.

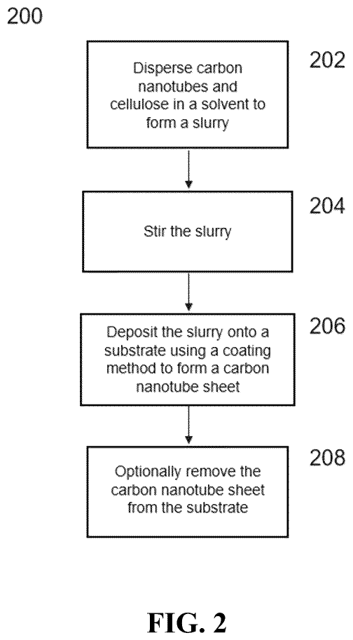

FIG. 2 is a flow chart of an exemplary method of making carbon nanotube sheets, according to embodiments of the present disclosure. In embodiments, the method 200 may include steps of: dispersing carbon nanotubes and cellulose in a solvent to form a slurry 202, stirring the slurry 204, depositing the slurry onto a substrate using a coating method to form a carbon nanotube sheet 206, and optionally removing the carbon nanotube sheet from the substrate 208.

Step 202 of the disclosed method may include dispersing carbon nanotubes and cellulose in a solvent to form a slurry. The carbon nanotubes may include single-walled carbon nanotubes, double-walled carbon nanotubes, multi-walled carbon nanotubes, or combinations thereof. The cellulose may include TEMPO-oxidized cellulose, bacterial cellulose, cellulose nanofibers, cellulose nanocrystals, CM250 cellulose, CM150 cellulose, and nanofibrillated cellulose and may be mechanically produced or chemically produced. The slurry may include 0.1 wt. % to about 95 wt. % cellulose, for example, 0.1 wt. %, about 1 wt. %, about 2 wt. %, about 3 wt. %, about 4 wt. %, about 5 wt. %, about 6 wt. %, about 7 wt. %, about 8 wt. %, about 9 wt. %, about 10 wt. %, about 11 wt. %, about 12 wt. %, about 13 wt. %, about 14 wt. %, about 15 wt. %, about 16 wt. %, about 17 wt. %, about 18 wt. %, about 19 wt. %, about 20 wt. %, about 21 wt. %, about 22 wt. %, about 23 wt. %, about 24 wt. %, about 25 wt. %, about 26 wt. %, about 27 wt. %, about 28 wt. %, about 29 wt. %, about 30 wt. %, about 31 wt. %, about 32 wt. %, about 33 wt. %, about 34 wt. %, about 35 wt. %, about 36 wt. %, about 37 wt. %, about 38 wt. %, about 39 wt. %, about 40 wt. %, about 41 wt. %, about 42 wt. %, about 43 wt. %, about 44 wt. %, about 45 wt. %, about 46 wt. %, about 47 wt. %, about 48 wt. %, about 49 wt. %, about 50 wt. %, about 51 wt. %, about 52 wt. %, about 53 wt. %, about 54 wt. %, about 55 wt. %, about 56 wt. %, about 57 wt. %, about 58 wt. %, about 59 wt. %, about 60 wt. %, about 61 wt. %, about 62 wt. %, about 63 wt. %, about 64 wt. %, about 65 wt. %, about 66 wt. %, about 67 wt. %, about 68 wt. %, about 69 wt. %, about 70 wt. %, about 71 wt. %, about 72 wt. %, about 73 wt. %, about 74 wt. %, about 75 wt. %, about 80 wt. %, about 85 wt. %, about 90 wt. %, about 95 wt. %, or any value contained within a range formed by any two of the preceding values. In embodiments, the slurry does not include any cellulose, that is, the slurry contains 0 wt. % cellulose.

The slurry may include about 5 wt. % carbon nanotubes to about 100 wt. % carbon nanotubes, for example, about 5 wt. %, about 10 wt. %, about 15 wt. %, about 20 wt. %, about 25 wt. %, about 30 wt. %, about 35 wt. %, about 40 wt. %, about 45 wt. %, about 50 wt. %, about 55 wt. %, about 60 wt. %, about 65 wt. %, about 70 wt. %, about 75 wt. %, about 80 wt. %, about 85 wt. about 90 wt. %, about 95 wt. %, about 100 wt. %, or any value contained within a range formed by any two of the preceding values. The solvent may include water, methanol, ethanol, acetone, dimethylformamide, tetrahydrofuran, dimethylacetamide, dimethyl sulfoxide, isopropyl alcohol, toluene, or combinations thereof. In embodiments, the solvent may include water and another fluid in a ratio by weight in a range of about 75:25 or about 0:100. For example, the solvent may include water and ethanol in a ratio by weight of about 75:25 to about 0:100 or the solvent may include water and acetone in a ratio by weight of about 75:25 to about 0:100. In embodiments, the solvent may include water and ethanol in a ratio of about 1:5, about 1:4, about 1:3, about 1:2, or any value or range contained therein.

Step 204 of the disclosed method may include stirring the slurry to combine the carbon nanotubes and cellulose in the solvent. Stirring the slurry may include stirring with a magnetic stirrer, sonication with a probe sonicator, mixing with planetary or centrifugal mixers, or combinations thereof. A magnetic stirrer and a probe sonicator may be used simultaneously or sequentially to stir the slurry according to embodiments of the present disclosure. For example, in embodiments, the carbon nanotube slurry may be stirred with a magnetic stirrer and subsequently sonicated with probe sonication, or the carbon nanotube slurry may be simultaneously stirred with a magnetic stirrer and probe sonication.

Step 206 of the disclosed method may include depositing the slurry onto a substrate, wherein the substrate may include a flexible or rigid metal, a metal alloy or metal oxide, a polymeric material, a ceramic, a glass, a glass-laminated polymer, a composite, or combinations thereof. The coating method may include tape casting, spray coating, ink-jet printing, dip coating, or combinations thereof. For example, in embodiments, the slurry may be deposited by spray coating and the disclosed process may be repeated such that multiple layers of slurry are deposited. It is contemplated that different coating methods may be combined in embodiments; for example, a first layer of slurry may be deposited onto the substrate by tape casting and a second layer of slurry may be deposited onto the substrate by spray coating. In embodiments, the slurry may be deposited by ink-jet printing, and the printing method and ink formulation may be adjusted to control the viscosity, deposition rate, and other factors according to the needs of a user of the disclosed method. In embodiments, a primer may be applied to the substrate prior to depositing the slurry. The primer may fill or smooth in any textural elements on the substrate, such that the carbon nanotube slurry is deposited evenly. For example, the substrate may include surface roughness or unevenness including but not limited to grooves, perforations, cracks, pebbles, dimples, etchings, or combinations thereof. In embodiments, the primer may include cellulose, polyethylene, paint primer, adhesive spray, or combinations thereof.

Step 208 of the disclosed method may include optionally removing the carbon nanotube sheet from the substrate such that the carbon nanotube sheet is freestanding. Any removal method known to those skilled in the art is acceptable for use in and within the scope of the present disclosure. The freestanding carbon nanotube sheet may be applied to a surface, or it may be used as a freestanding sheet.

There is provided a carbon nanotube sheet which may be produced by methods of the present disclosure. The carbon nanotube sheet may include carbon nanotubes and cellulose. In embodiments, the carbon nanotube sheet includes 0 wt. % to about 95 wt. % cellulose, or about 5 wt. % to about 50 wt. % cellulose. The carbon nanotube sheet may include cellulose from different sources, including but not limited to TEMPO-oxidized cellulose, bacterial cellulose, cellulose nanofibers, cellulose nanocrystals, and nanofibrillated cellulose.

The carbon nanotube sheet may exhibit an emissivity of about 0.03 to about 0.7, according to embodiments of the present disclosure, such as about 0.03, about 0.05, about 0.1, about 0.15, about 0.2, about 0.25, about 0.3, about 0.35, about 0.4, about 0.45, about 0.5, about 0.55, about 0.6, about 0.65, about 0.7, or any value contained within a range formed by any two of the preceding values. In embodiments, the emissivity of the carbon nanotube sheet is about 0.05 to about 0.3. The emissivity of the carbon nanotube sheet may be measured according to methods known to those skilled in the art, including by using an emissivity measurement apparatus, such as a forward looking infrared (FLIR) camera or a spectroradiometer. The carbon nanotubes used in the formation of the carbon nanotube sheets may influence the resulting emissivity and other properties of the sheets. For example, and without wishing to be bound by theory, single-walled carbon nanotubes may yield carbon nanotube sheets that have lower emissivity and lower weight, which may be advantageous in applications.

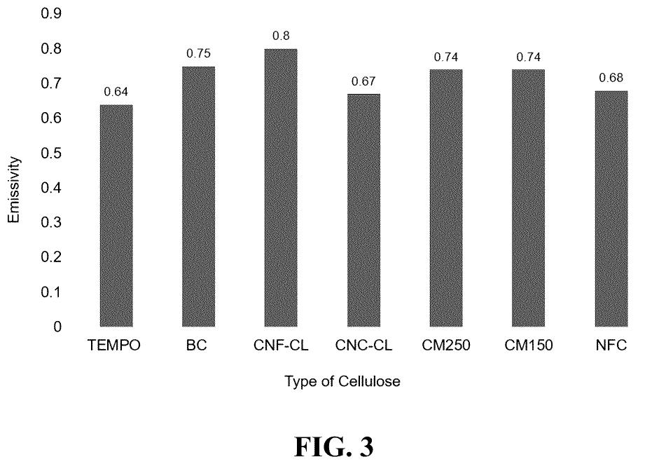

The type of cellulose used may influence various properties of the carbon nanotube sheet, including emissivity. FIG. 3 is a bar graph showing the relationship between the emissivity of the carbon nanotube sheets and the type of cellulose in the carbon nanotube sheets. The carbon nanotube sheets measured for FIG. 3 include multi-walled carbon nanotubes and various types of cellulose (at about 15 wt. % in all examples), including TEMPO-oxidized cellulose, bacterial cellulose, cellulose nanofibers, cellulose nanocrystals, CM250 cellulose, CM150 cellulose, and nanofibrillated cellulose. The surface area of the cellulose may vary and is not particularly limited. In embodiments, the surface area of the cellulose used in the carbon nanotube sheets described herein may be about 120 m²/g to about 350 m²/g. As shown in FIG. 3, the emissivity of the carbon nanotube sheets is lowest when TEMPO-oxidized cellulose is used.

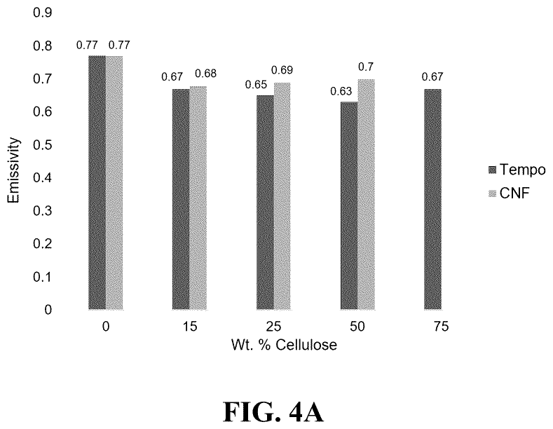

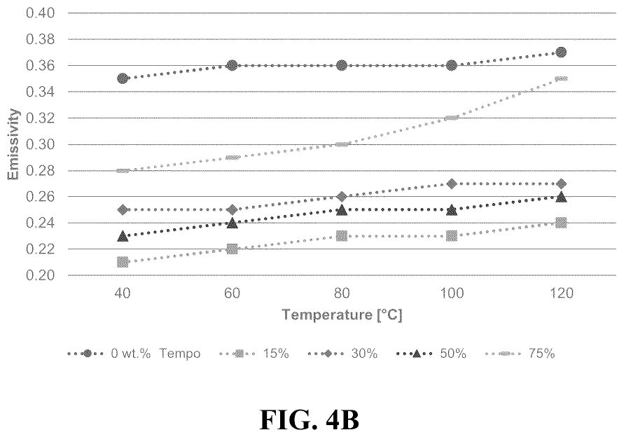

According to embodiments of the present disclosure, the carbon nanotube sheet may include 0.1 wt. % to about 95 wt. % cellulose relative to the total weight of the carbon nanotube sheet. The remainder of the carbon nanotube sheet may include carbon nanotubes and other additives as described herein such that the total composition adds up to 100 wt. %. For example, in embodiments which include cellulose, the amount of cellulose in the carbon nanotube sheet relative to the total composition of the carbon nanotube sheet may be 0.1 wt. % to about 95 wt. %, for example, about 0.1 wt. %, about 1 wt. %, about 5 wt. %, about 10 wt. %, about 15 wt. %, about 20 wt. %, about 25 wt. %, about 30 wt. %, about 35 wt. %, about 40 wt. %, about 45 wt. %, about 50 wt. %, about 55 wt. %, about 60 wt. %, about 65 wt. %, about 70 wt. %, about 75 wt. %, about 80 wt. %, about 85 wt. %, about 90 wt. %, about 95 wt. %, or any value contained within a range formed by any two of the preceding values. The amount of cellulose included in the carbon nanotube sheet may influence various properties of the carbon nanotube sheet, such as emissivity. FIG. 4A is a bar graph showing the relationship between the emissivity of the carbon nanotube sheets and the weight percentage of cellulose included in the carbon nanotube sheets. The carbon nanotube sheets of FIG. 4A were fabricated using multi-walled carbon nanotubes (MWCNT) and compared TEMPO-oxidized cellulose with cellulose nanofibers (CNF). As shown in FIG. 4A, the CNF-based carbon nanotube sheets gave generally higher emissivity than the TEMPO-oxidized cellulose-based sheets with the same amount of cellulose. FIG. 4B is a graph showing the relationship between emissivity of the carbon nanotubes and the weight percentage of cellulose included in the carbon nanotube sheets, when single single-walled carbon nanotubes and varying the temperature. As shown and when compared to FIG. 4A, single-walled carbon nanotubes (SWCNT) provide lower emissivities than MWCNT.

The carbon nanotube sheet of the present disclosure may include multiple layers, such as 1 layer to about 10 layers. For example, the carbon nanotube sheets may include 1 layer, 2 layers, 3 layers, 4 layers, 5 layers, 6 layers, 7 layers, 8 layers, 9 layers, or 10 layers. According to embodiments of the present disclosure, the carbon nanotube sheet may have a thickness of about 10 μm to about 130 μm. For example, the carbon nanotube sheet may have a thickness of about 10 μm, about 20 μm, about 30 μm, about 40 μm, about 50 μm, about 60 μm, about 70 μm, about 80 μm, about 90 μm, about 100 μm, about 110 μm, about 120 μm, about 130 μm, or any value contained within a range formed by any two of the preceding values.

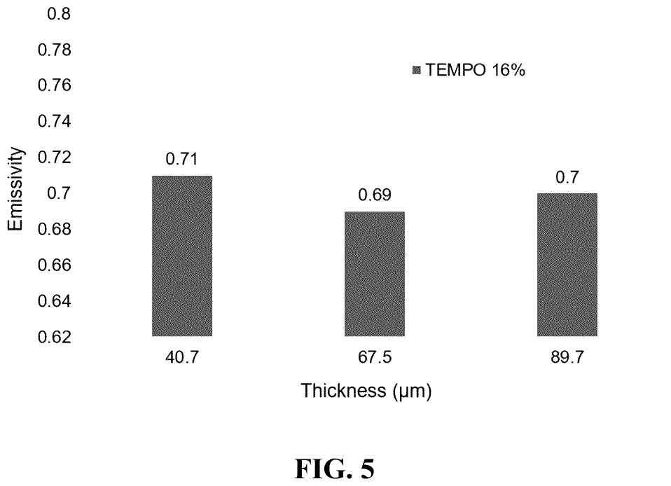

The relationship between thickness of the carbon nanotube sheets and emissivity was also investigated. FIG. 5 is a bar graph showing the relationship between the emissivity of the carbon nanotube sheets and the thickness of the carbon nanotube sheets. As shown in FIG. 5, there is not a significant correlation between sheet thickness and emissivity, as a carbon nanotube sheet with a thickness of 40.7 μm had a similar emissivity as a carbon nanotube sheet with a thickness of 89.7 μm. Without wishing to be bound by theory, it is hypothesized that varying the weight percentage of cellulose in the carbon nanotube sheet and the use of multi-walled carbon nanotubes vs. single-walled carbon nanotubes offer a robust method to influence emissivity.

In embodiments, the carbon nanotube sheet is freestanding. In other embodiments, the carbon nanotube sheet is provided on a substrate. The substrate may include a flexible or rigid metal, a metal alloy or metal oxide, a polymeric material, a ceramic, a glass, a glass-laminated polymer, a composite, or combinations thereof.

There is provided a method for providing infrared (IR) shielding to a surface, according to embodiments of the present disclosure. IR shielding may include temperature control in buildings or vehicles in areas with high amounts of direct sunlight, to reduce cooling costs and power requirements. IR shielding may also include preventing the object from being detected by IR cameras or other unwanted surveillance. It is also contemplated that IR shielding may be employed in wearable technology.

The method for providing infrared shielding to a surface may include applying the carbon nanotube sheet of the present disclosure to the surface. Applying the carbon nanotube sheet to the surface may include fabricating the carbon nanotube sheet onto the surface, applying a freestanding carbon nanotube sheet to the surface, applying first a primer and second a freestanding carbon nanotube sheet to the surface, and applying two or more carbon nanotube sheets to the surface. The type of surface is not particularly limited. It is contemplated that the surface may be a building, window, vehicle, barrier, wearable device or article, or any other surface that may benefit from IR shielding.

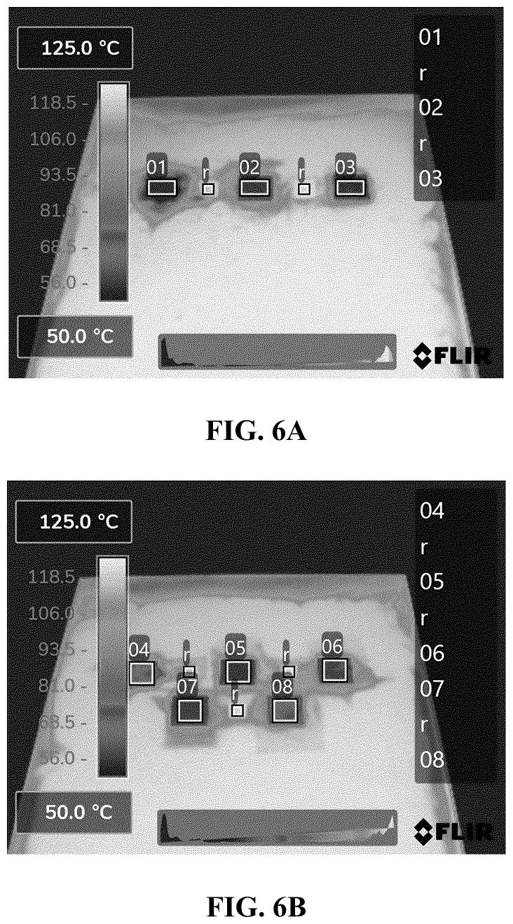

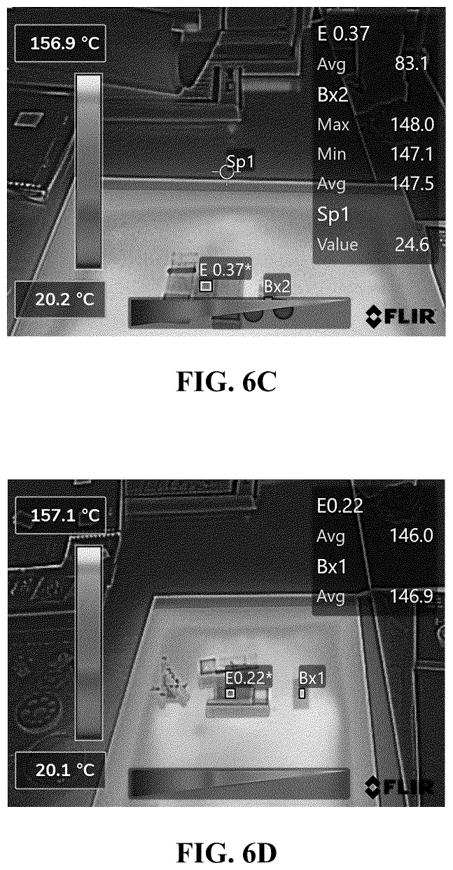

FIG. 6A and FIG. 6B are FLIR measurements of samples of carbon nanotube sheets produced according to embodiments of the present disclosure. Scotch Tape Super 88 was used as a reference due to its known emissivity and is shown in FIG. 6A and FIG. 6B as the squares labeled “r”. The samples are the darker squares labeled “01”, “02”, and “03” in FIG. 6A and “04”, “05”, “06”, “07”, and “08” in FIG. 6B. The darker sample squares show that less thermal radiation is being detected from the sample squares than from the background or reference. FIG. 6A and FIG. 6B demonstrate the efficacy of the carbon nanotube sheet samples in reducing the emission of thermal radiation from the surface on which they are placed and supports the IR shielding capabilities of the carbon nanotube sheets. FIG. 6C is a thermograph for the heating plate and a sample containing pure SWCNT showing the temperature field distribution, where the plate temperature was set to 150° C. FIG. 6D is a thermograph for the heating plate and a sample containing SWCNT and 30 wt. % cellulose, according to an embodiment of the present disclosure, showing the temperature field distribution, where the plate temperature was set to 150° C. FIG. 6C and FIG. 6D further support the IR shielding capabilities of the carbon nanotube sheets of the present disclosure.

### Examples

Carbon nanotube sheets were prepared according to embodiments of the present disclosure. Several samples of carbon nanotube sheets were prepared according to the methods disclosed herein, varying the amount of cellulose present in the slurry to prepare Samples 1-8 as shown below in TABLE 1. For example, Sample 1 in TABLE 1 below was prepared by combining 0.05 g of single-walled carbon nanotubes with 0.75 g of nanocellulose in a 1:1 mixture of water and ethanol (7.5 ml of each) and stirring with a magnetic stirrer and probe sonication for 20 minutes in an ice bath. The resulting slurry was cast onto a copper film substrate via tape casting. The preparation of Samples 2-8 followed the same procedure with different amounts of cellulose to achieve the disclosed weight percentages. The emissivity of the carbon nanotube sheet was measured using an FLIR camera. Emissivity of the samples as measured and ease of peeling from the substrate is reported in TABLE 1 below.

TABLE 1

| | | | | | Ease of | |
|---|---|---|---|---|---|---|
| | | | | | Peeling | |
| Sample | Thickness | | Type of | Wt. % | from | |
| Number | (μm) | Type of CNT | Cellulose | Cellulose | Substrate | Emissivity |
| 1 | 14.7 | Single-walled | TEMPO | 15 | Difficult | 0.25 |
| 2 | 25.7 | Single-walled | TEMPO | 15 | Easy | 0.26 |
| 3 | 39.8 | Single-walled | TEMPO | 15 | Easy | 0.25 |
| 4 | N/A | Single-walled | TEMPO | 15 | N/A | 0.17 |
| 5 | 18.9 | Single-walled | TEMPO | 0 | Easy | 0.36 |
| 6 | 18.9 | Single-walled | TEMPO | 0 | Easy | 0.37 (at |
| | | | | | | 150° C. |
| 7 | 25.7 | Single-walled | TEMPO | 15 | Easy | 0.23 |
| 8 | 15.6 | Single-walled | TEMPO | 30 | Easy | 0.26 |
| 9 | 15.6 | Single-walled | TEMPO | 30 | Easy | 0.22 (at |
| | | | | | | 150° C.) |
| 11 | 18.1 | Single-walled | TEMPO | 50 | Easy | 0.25 |
| 12 | 39.8 | Single-walled | TEMPO | 75 | Easy | 0.31 |
| 13 | 5.7 | Single-walled | TEMPO | 15 | Easy | 0.24 |
| | | (17 wt. % of Al | | | | |
| | | added) | | | | |
| 14 | 8.8 | Single-walled | TEMPO | 15 | Easy | 0.25 |
| | | (34 wt. % of Al | | | | |
| | | added) | | | | |
| 15 | 25.8 | Single-walled | TEMPO | 15 | Easy | 0.25 |
| | | (42 wt. % of Al | | | | |
| | | added) | | | | |
| 16 | 15.1 | Single-walled | TEMPO | 15 | Easy | 0.26 |
| | | (68 wt. % of Al | | | | |
| | | added) | | | | |
| 17 | 36.2 | Multi-walled | TEMPO | 0 | Easy | 0.77 |
| 18 | 37.2 | Multi-walled | TEMPO | 15 | Easy | 0.67 |
| 19 | 32.2 | Multi-walled | TEMPO | 25 | Easy | 0.65 |
| 20 | 22.5 | Multi-walled | TEMPO | 50 | Easy | 0.63 |
| 21 | 14.8 | Multi-walled | TEMPO | 75 | Difficult | 0.67 |
| 22 | 41.0 | Multi-walled | NFC | 15 | Easy | 0.68 |
| 23 | 41.8 | Multi-walled | NFC | 25 | Easy | 0.69 |
| 24 | 44.8 | Multi-walled | NFC | 50 | Easy | 0.7 |

As shown in TABLE 1, the emissivity of Samples 1-20 varies with different parameters of the carbon nanotube sheet. Samples 1-4, which use single-walled carbon nanotubes (CNT), demonstrate that the thickness of the sheet does not have a significant effect on emissivity, but thinner sheets are more difficult to remove from the substrate. This relationship is further demonstrated in FIG. 5 with multi-walled CNT and thicker sheets; as shown, there is not a strong correlation between increasing thickness and emissivity.

Samples 5-9 in TABLE 1 demonstrate the effect of varying the weight percentage of cellulose in a single-walled carbon nanotube sheet. Cellulose content was varied from 0 wt. % to 75 wt. %, using the same TEMPO-oxidized cellulose in each sample. As shown in TABLE 1, when cellulose content was between about 15 wt. % to 50 wt. %, the measured emissivity was lower than for Samples 5 and 9 which contained 0 wt. % and 75 wt. % cellulose, respectively. Samples 14-18 and FIG. 4 demonstrate this same correlation with multi-walled carbon nanotubes.

Samples 10-13 in TABLE 1 investigate the effect of an additive, in this case aluminum powder, on the carbon nanotube sheet. Single-walled CNT and about 15 wt. % of cellulose were used to prepare Samples 10-13, with varying amounts of aluminum powder added. Carbon nanotube sheets with about 17 wt. % aluminum to about 68 wt. % aluminum yielded emissivity values similar to equivalent sheets without aluminum.

Samples 19-21 utilize a different source of cellulose, nanofibrillated cellulose (NFC). As shown, and without wishing to be bound by theory, these samples gave slightly higher emissivity values than equivalent sheets formed from TEMPO-oxidized cellulose.

The lowest emissivity value of 0.17 of TABLE 1 was achieved in Sample 4 which contains single-walled carbon nanotubes with 15 wt. % cellulose. It is expected that further studies on the relationship between type and weight percentage of cellulose, processing method, additives, and other factors will yield still lower emissivities.

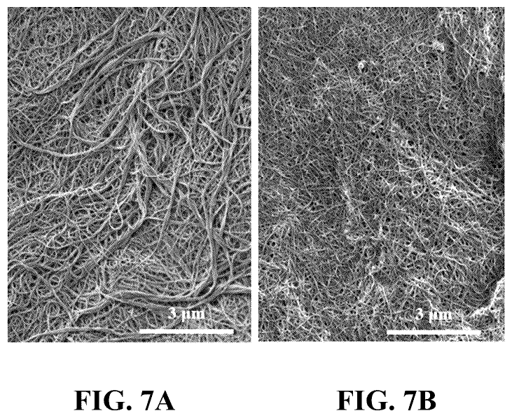

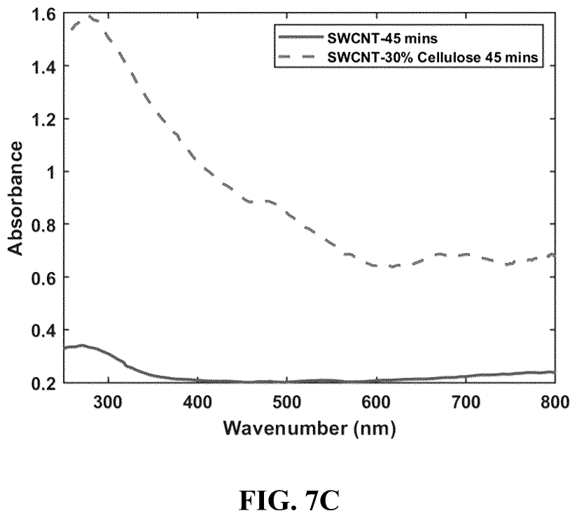

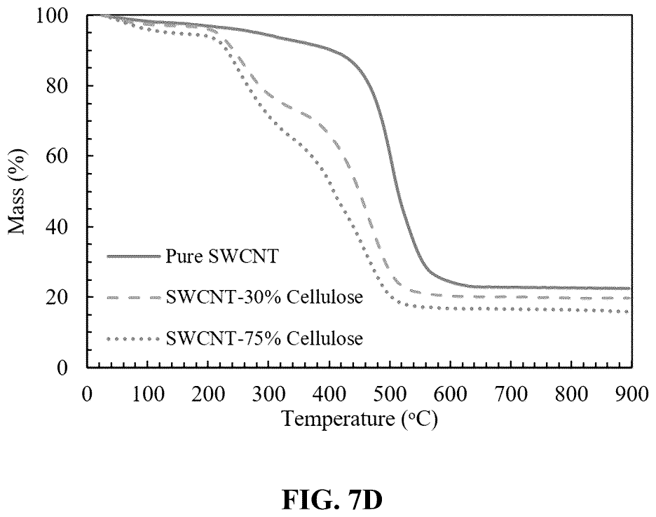

FIG. 7A is an SEM image of a SWCNT sheet that does not contain cellulose, and FIG. 7B is an SEM image of a SWCNT sheet containing 30 wt. % cellulose, according to an embodiment of the present disclosure. SEM images were employed to investigate the morphology of the fabricated freestanding carbon nanotube sheets of the present disclosure and to reveal any possible alterations in pore sizes and fiber arrangements between the SWCNT sheets that do not contain cellulose (pure SWCNT buckypaper) and the sheets modified with 30 wt. % cellulose. The micrographs in FIG. 7A and FIG. 7B demonstrate the organization of the carbon nanotubes in the samples. It can be observed that as the percentage of cellulose is increased, the CNT fibers are more separated and finer in nature (FIG. 7B) while in the sample which does not contain cellulose, the CNTs are more stuck together, forming thicker bundles (FIG. 7A).

Without wishing to be bound by theory, this separation observed could be due to the dispersant effect of the cellulose which may cause the SWCNT to have a more spread-out distribution while casting, as can also be verified through UV-Vis spectroscopy (FIG. 7C). FIG. 7C is a UV-Vis spectra for SWCNT and SWCNT/30 wt. % cellulose after 45 minutes of sonication, according to an embodiment of the present disclosure, showing the higher dispersion with nanocellulose. The higher absorbance (around 1.6) at 250 nm of the sample with 30 wt. % cellulose indicates that the SWCNT is more dispersed in the liquid solution compared to the lower absorbance of the pure CNT (approximately 0.35). It is contemplated that this lower absorbance may be because fewer particles are dispersed without cellulose, allowing more light to pass through.

Thermogravimetric (TGA) tests were also performed to determine the thermal stability of the SWCNT and SWCNT-cellulose samples. FIG. 7D shows thermogravimetric (TGA) results for SWCNT with 0 wt. %, 30 wt. % and 75 wt. % cellulose under oxygen gas flow. TGA results demonstrate the high thermal stability of the pure SWCNT which does not contain cellulose, as there is a slow decrease in mass % until 450° C., up to 80 mass %, after which there is a sharp drop to 25 mass % at around 565.5° C. The other two samples with 30 wt. % and 75 wt. % cellulose, however, showed steep reduction in mass from 210° C., contemplated to correspond to the water loss from the cellulose, and again at 390° C. which is contemplated to represent the thermal decomposition of organic matter. This indicates that the operating temperature of the SWCNT films with varying cellulose percentage is below 210° C., as degradation of cellulose begins at temperatures about 210° ° C.

As the TGA results demonstrated thermal stability of the samples below 210° C. infrared shielding was also tested at 150° C. for the pure SWCNT and SWNCT-30 wt. % cellulose samples. It was found that the emissivity of the samples is 0.37 and 0.22, respectively, demonstrating enhanced infrared shielding behavior is maintained at higher temperatures for the sample with 30 wt. % cellulose (as shown in FIG. 6C and FIG. 6D).

This disclosure is not limited to the particular systems, devices and methods described, as these may vary. The terminology used in the description is for the purpose of describing the particular versions or embodiments only and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” et cetera). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups. It will be further understood by those within the art that if a specific number of an introduced claim recitation is intended, such an intent will be explicitly recited in the claim, and in the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, et cetera. As a non-limiting example, each range discussed herein can be readily broken down into a lower third, middle third and upper third, et cetera. As will also be understood by one skilled in the art all language such as “up to,” “at least,” and the like include the number recited and refer to ranges that can be subsequently broken down into subranges as discussed above. Finally, as will be understood by one skilled in the art, a range includes each individual member. Thus, for example, a group having 1-3 compounds refers to groups having 1, 2, or 3 compounds. Similarly, a group having 1-5 compounds refers to groups having 1, 2, 3, 4, or 5 compounds, and so forth.

Various of the above-disclosed and other features and functions, or alternatives thereof, may be combined into many other different systems or applications. Various presently unforeseen or unanticipated alternatives, modifications, variations, or improvements therein may be subsequently made by those skilled in the art, each of which is also intended to be encompassed by the disclosed embodiments.

What is claimed is:

1. A method for producing carbon nanotube sheets, the method comprising steps of:
dispersing carbon nanotubes and cellulose in a solvent to form a slurry,
stirring the slurry, and
depositing the slurry onto a substrate using a coating method to form a carbon nanotube sheet.

2. The method of claim 1, wherein the carbon nanotubes comprise single-walled carbon nanotubes, double-walled carbon nanotubes, multi-walled carbon nanotubes, or combinations thereof.

3. The method of claim 1, wherein the slurry comprises 0.1 wt. % to 95 wt. % cellulose.

4. The method of claim 1, wherein the solvent comprises water, ethanol, methanol, isopropanol, acetone, dimethylformamide, tetrahydrofuran, dimethylacetamide, dimethyl sulfoxide, toluene, or combinations thereof.

5. The method of claim 1, wherein the solvent comprises water and ethanol in a ratio of 1:5 to 1:2.

6. The method of claim 1, wherein stirring the slurry comprises stirring with a magnetic stirrer, sonicating, or combinations thereof.

7. The method of claim 1, wherein the substrate comprises a metal, polymer, ceramic, glass, composite, or combinations thereof.

8. The method of claim 1, wherein the coating method comprises tape casting, spray coating, ink-jet printing, dip coating, or combinations thereof.

9. The method of claim 1, wherein the carbon nanotube sheet comprises 0.1 wt. % to 95 wt. % cellulose.

10. The method of claim 1, wherein the method further comprises depositing multiple layers of slurry onto a substrate to form a carbon nanotube sheet with multiple layers.

11. The method of claim 1, wherein the method further comprises a step of removing the carbon nanotube sheet from the substrate to form a freestanding carbon nanotube sheet.

12. A carbon nanotube sheet, comprising:
carbon nanotubes and 0.1 wt. % to 95 wt. % cellulose.

13. The carbon nanotube sheet of claim 12, wherein the carbon nanotube sheet comprises 5 wt. % to 50 wt. % cellulose.

14. The carbon nanotube sheet of claim 12, wherein the carbon nanotube sheet comprises between 1 layer and 10 layers.

15. The carbon nanotube sheet of claim 12, wherein the carbon nanotube sheet has a thickness of 30 μm to 130 μm.

16. The carbon nanotube sheet of claim 12, wherein the carbon nanotube sheet has an emissivity of 0.03 to 0.7.

17. The carbon nanotube sheet of claim 12, wherein the carbon nanotube sheet has an emissivity of 0.05 to 0.3.

18. The carbon nanotube sheet of claim 12, wherein the carbon nanotube sheet is freestanding.

19. A method of providing infrared shielding to a surface, comprising: applying the carbon nanotube sheet of claim 12 to the surface.

20. The method of claim 19, wherein applying the carbon nanotube sheet comprises one or more of fabricating the carbon nanotube sheet onto the surface, applying a freestanding carbon nanotube sheet to the surface, applying first a primer and second a freestanding carbon nanotube sheet to the surface, and applying two or more carbon nanotube sheets to the surface.
